(19) United States
(12) Patent Application Publication
(10) Pub. No.: US 2019/0318676 A1
(43) Pub. Date: Oct. 17, 2019

(54) ELECTRONIC DEVICE FOR SENSING AND COMPENSATING FOR DETERIORATION CAUSED IN DISPLAY

(71) Applicant: Samsung Electronics Co., Ltd., Gyeonggi-do (KR)

(72) Inventors: Hoyoung JUNG, Gyeonggi-do (KR); Wonhee CHOE, Gyeonggi-do (KR); Nari KIM, Gyeonggi-do (KR)

(21) Appl. No.: 16/383,796

(22) Filed: Apr. 15, 2019

(30) Foreign Application Priority Data
Apr. 13, 2018 (KR) 10-2018-0043472

(51) Int. Cl. G09G 3/00; G06T 7/00; H04N 5/232; G02B 5/08; H04N 19/176

(52) U.S. Cl. CPC G09G 3/006; G06T 7/0004; H04N 19/176; G02B 5/08; H04N 5/23229

(57) ABSTRACT

Disclosed is an electronic device including a display, a camera, a communication circuit, a memory, and a processor. The processor may obtain by using the camera or receive from an external device by using the communication circuit, a first image corresponding to a first display image having a uniformly repeated pattern and output through the display or another display included in the external device, obtain by using the camera or receive from the external device by using the communication circuit, a second image corresponding to a second display image having the same gradation and output through the display or the other display, identify some deteriorated pixels among pixels included in the display or the other display by using the second image, determine location information of the deteriorated pixels by using the uniformly repeated pattern, and generate compensation information for the deteriorated pixels based on the location information.

### CROSS-REFERENCE TO RELATED APPLICATION(S)

This application is based on and claims priority under 35 U.S.C. § 119 to Korean Patent Application No. 10-2018-0043472, filed on Apr. 13, 2018, in the Korean Intellectual Property Office, the disclosure of which is incorporated by reference herein its entirety.

### BACKGROUND

### 1. Field

Embodiments of the disclosure generally relate to technology for sensing and compensating for deterioration that occurs in a display.

### 2. Description of Related Art

Displays may output various types of images, pictures, and the like by controlling pixels included in the displays to emit light. As such, the loads applied to pixels may be different from each other, and accordingly, the speeds at which pixels deteriorate may also be different from each other. The difference between the deteriorations occurring in pixels may cause a screen afterimage. For example, a pixel with a relatively large amount of deterioration may be darker than a pixel with a relatively small amount of deterioration. Thus, screen afterimages may be generated for images that are persistently displayed on the displays, such as those for a home key, a back key, a menu key, or the like.

The above information is presented as background information only to assist with an understanding of the disclosure. No determination has been made, and no assertion is made, as to whether any of the above might be applicable as prior art with regard to the disclosure.

### SUMMARY

In order to detect which of the pixels has deteriorated, the electronic device housing the display may obtain an image output through the display. The electronic device may analyze the image to detect the pixels that are deteriorated. However, when the display panel housed in the electronic display is curved, the locations of the pixels calculated based on the image may be different from the locations where the pixels are actually arranged because the panel is curved but the image is flat. Thus, it may be difficult for the electronic device to clearly detect the locations of pixels where deterioration has occurred.

In addition, the electronic device may compensate for pixels that have deteriorated based on the image. However, the amount of deterioration occurring may not be clearly displayed in the image. Thus, when the electronic device compensates for deterioration based on the image, the amount of compensation may not be appropriate for the actual amount of deterioration, i.e., the amount of compensation may be more or less than necessary for the amount of deterioration.

Aspects of the disclosure are to address at least the above-mentioned problems and/or disadvantages and to provide at least the advantages described below. Accordingly, an aspect of the disclosure is to provide an electronic device.

In accordance with an aspect of the disclosure, an electronic device includes a display, a camera, a communication circuit, a memory, and a processor, wherein the processor may obtain by using the camera or receive from an external device by using the communication circuit, a first image corresponding to a first display image having a uniformly repeated pattern and output through the display or another display included in the external device, obtain by using the camera or receive from the external device by using the communication circuit, a second image corresponding to a second display image having a same gradation and output through the display or the other display, identify one or more deteriorated pixels among a plurality of pixels included in the display or the other display by using the second image, determine location information of the one or more deteriorated pixels by using the uniformly repeated pattern included in the first image, and generate compensation information for the one or more deteriorated pixels based on the location information.

In accordance with another aspect of the disclosure, a method of detecting and compensating for deterioration of pixels included in a display or another display of an external device includes obtaining by using a camera or receiving from the external device by using a communication circuit, a first image corresponding to a first display image having a uniformly repeated pattern and output through the display or the other display included in the external device, obtaining by using the camera or receiving from the external device by using the communication circuit, a second image corresponding to a second display image having a same gradation and output through the display or the other display, identifying one or more deteriorated pixels among a plurality of pixels included in the display or the other display by using the second image, determining location information of the one or more deteriorated pixels by using the uniformly repeated pattern included in the first image, and generating compensation information for the one or more deteriorated pixels based on the location information.

In accordance with still another aspect of the disclosure, a server includes a communication circuit, and a processor electrically connected to the communication circuit, wherein the processor may receive, from a first external device by using the communication circuit, a first image corresponding to a first display image output through a display included in a second external device and having a uniformly repeated pattern, receive, from the first external device by using the communication circuit, a second image corresponding to a second display image having a same gradation and output through the display, identify one or more deteriorated pixels among a plurality of pixels included in the display by using the second image, determine location information of the one or more deteriorated pixels by using the uniformly repeated pattern included in the first image, generate compensation information for the one or more deteriorated pixels based on the location information, and transmit the generated compensation information to the second external device through the communication circuit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an operating environment of a deterioration sensing device according to an embodiment;

FIG. 2A is a flowchart illustrating operations of a first electronic device and/or a second electronic device according to an embodiment;

FIG. 2B is a flowchart illustrating operations of a first electronic device and/or a second electronic device according to another embodiment;

FIG. 3 are views illustrating a process in which an electronic device according to an embodiment corrects a first image;

FIG. 4A, FIG. 4B, and FIG. 4C are view illustrating second images according to certain embodiments;

FIG. 5 is a graph illustrating average brightness values of second images according to an embodiment;

FIG. 6 is a view illustrating moires according to an embodiment;

FIG. 7 are graphs illustrating compensation for pixel deterioration according to an embodiment;

FIG. 8 is a view illustrating a scratch on a display or a foreign substance adhering to a display according to an embodiment;

FIG. 9 is a view illustrating an operating environment of an electronic device capable of measuring state data of a display according to another embodiment;

FIG. 10 is a cross-sectional view of a case device according to another embodiment;

FIG. 11 is a view illustrating an output screen of the first electronic device according to another embodiment;

FIG. 12A is a view illustrating a screen obtained by a first electronic device when measuring a middle area of a third electronic device according to another embodiment;

FIG. 12B is a view illustrating a screen obtained by a first electronic device when measuring an edge area of a third electronic device according to another embodiment;

FIG. 13 is a view illustrating a layout of a second electronic device and a third electronic device according to yet another embodiment;

FIG. 14 is a block diagram of an electronic device in a network environment according to certain embodiments; and

FIG. 15 is a block diagram of a display device according to certain embodiments.

### DETAILED DESCRIPTION

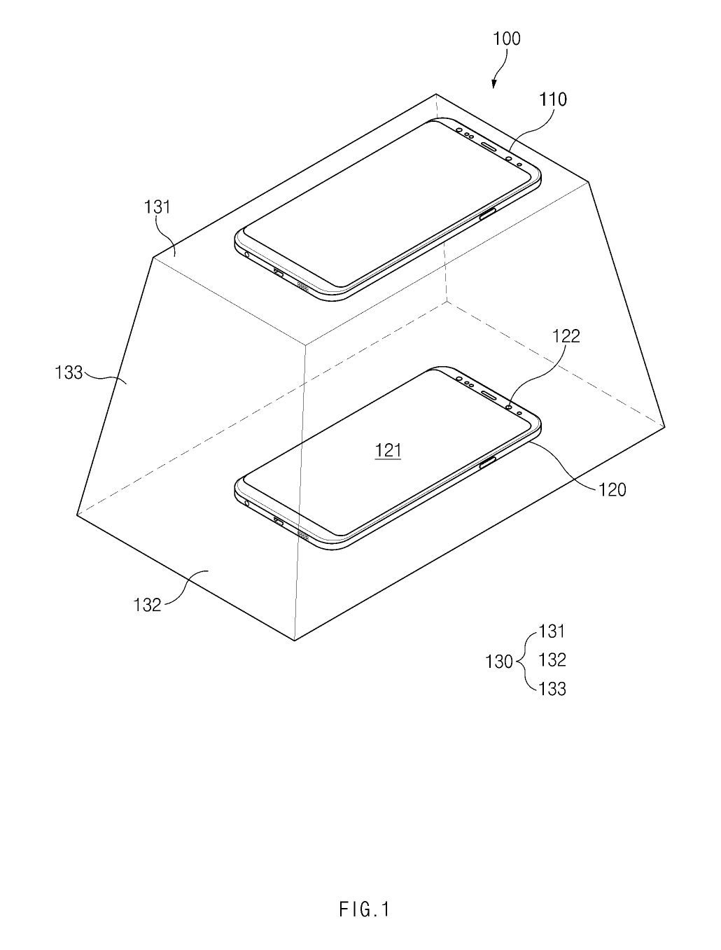

FIG. 1 is a view illustrating an operating environment of a deterioration sensing device according to an embodiment.

Referring to FIG. 1, first and second electronic devices 110 and 120 may be mounted on a case device 130 in order to sense deterioration. In the disclosure, each of the first and second electronic devices 110 and 120 may be referred to as a deterioration sensing device, a deterioration compensation device, a smart phone, or the like.

The case device 130 includes a first surface 131, a second surface 132 facing the first surface 131, and a side surface 133 surrounding the space between the first and second surfaces 131 and 132. According to an embodiment, because the case device 130 is hermetically closed, the space enclosed by the case device 130 may function as a darkroom.

The first electronic device 110 may be arranged on the first surface 131. In this case, a camera (e.g. rear camera) of the first electronic device 110 may be oriented toward the inside of the case device 130.

The second electronic device 120 may be arranged on the second surface 132. In this case, a display 121 of the second electronic device 120 may face the first surface 131.

According to an embodiment, the first electronic device 110 may photograph a first image output through the display 121 using its camera. In the present disclosure, the first image may include a uniformly repeated pattern. For example, the first image may include a first lattice pattern formed by controlling the pixels of the display 121 to alternately output light of different colors.

In addition, the first electronic device 110 may photograph at least one second image output through the display 121 through its camera. In the present disclosure, the second image may have the same overall gradation. For example, the second image may be generated when the pixels of the display 121 output a single series of light. When the first image and the at least one second image are photographed, the first electronic device 110 may use the two images to detect deterioration in the pixels.

The first electronic device 110 may calculate data (e.g., a compensation map) for compensating for pixels that are deteriorated. The calculated data may be transmitted to the second electronic device 120 and the second electronic device 120 may compensate for the deteriorated pixels based on the transmitted data. For example, the second electronic device 120 may reduce the brightness difference between the deteriorated pixels and the pixels that are not deteriorated based on the transmitted data. Thus, the second electronic device 120 may increase the brightness of the deteriorated pixels and/or reduce the brightness of pixels that are not deteriorated.

According to another embodiment, the first electronic device 110 may photograph the first image output through the display 121 through its camera. In addition, the first electronic device 110 may photograph at least one second image output through the display 121 through its camera. When the first image and the at least one second image are photographed, the first electronic device 110 may transmit the first image and the at least one second image to the second electronic device 120. The first electronic device 110 may transmit the first image and the at least one second image through a server (not shown), or the first electronic device 110 may directly transmit the first image and the at least one second image to the second electronic device 120. The second electronic device 120 may detect deteriorated pixels based on the received first image and the at least one second image.

The second electronic device 120 may calculate data (e.g., a compensation map) for compensating for the deteriorated pixels. When the data is calculated, the second electronic device 120 may compensate for the deteriorated pixels based on the calculated data. For example, the second electronic device 120 may reduce the brightness difference between the deteriorated pixels and the pixels that are not deteriorated, based on the transmitted data. Thus, the second electronic device 120 may increase the brightness of the deteriorated pixels and/or reduce the brightness of the pixels that are not deteriorated.

According to still another embodiment, a mirror, rather than the first electronic device 110, may be arranged on the first surface 131 of the case device 130. The second electronic device 120 may photograph the image reflected from the mirror through the camera 122. That is, the first image output through the display 121 may be reflected from the mirror, and the second electronic device 120 may photograph the first image from the mirror. In addition, at least one second image output through the display 121 may be reflected from the mirror, and the second electronic device 120 may photograph the reflected at least one second image. The second electronic device 120 may detect deteriorated pixels based on the first and second images. When the deteriorated pixels are detected, the second electronic device 120 may compensate for the deteriorated pixels.

In the disclosure, the description of FIG. 1 may be applied to configurations having the same reference numerals as those of the operating environment of the deterioration sensing device shown in FIG. 1. In addition, the embodiments described in FIG. 1 are exemplary and a deterioration sensing method and a deterioration compensation method described below may be performed by the first electronic device 110 and/or the second electronic device 120.

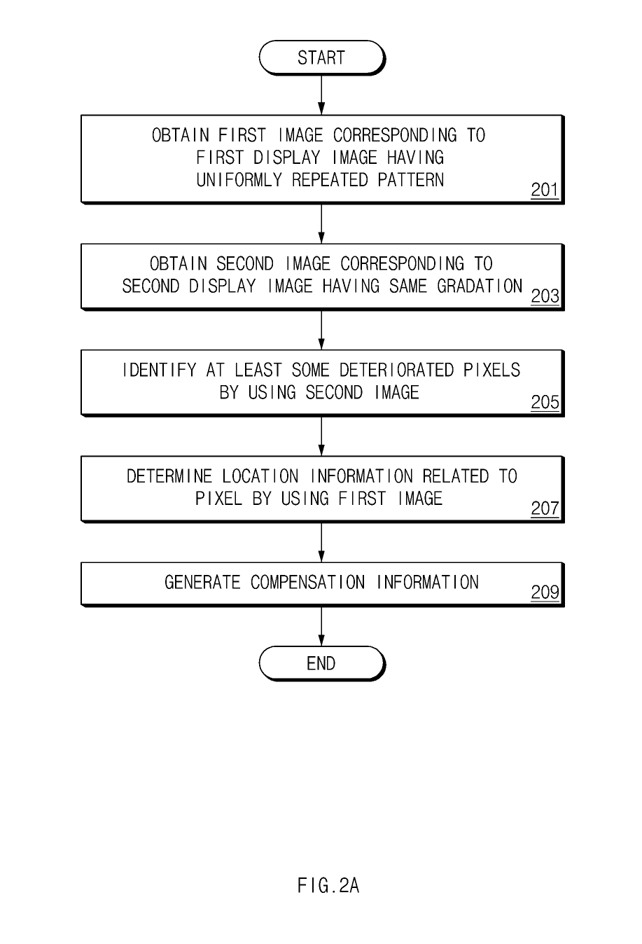

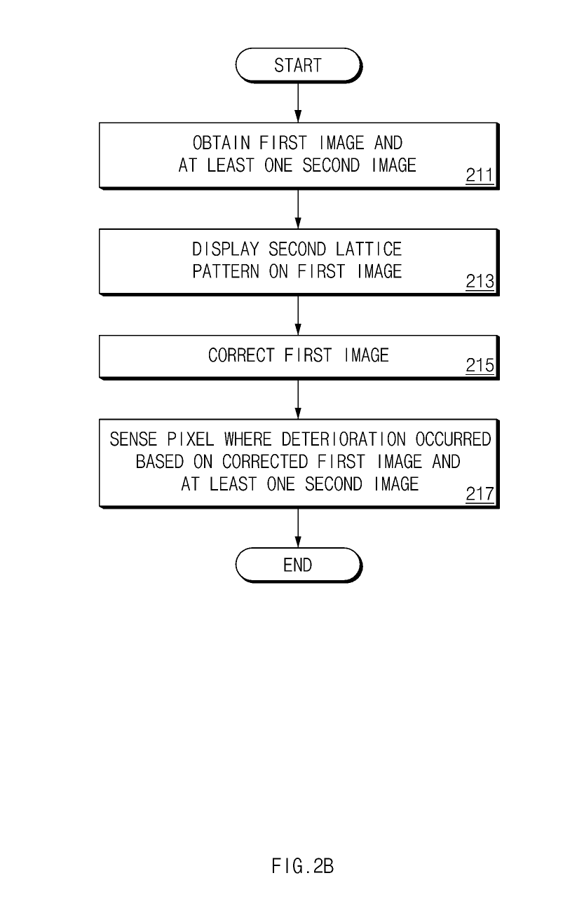

FIG. 2A is a flowchart illustrating operations of a first electronic device and/or a second electronic device according to an embodiment. All or some of the operations of FIG. 2A may be performed by the first electronic device 110 and/or the second electronic device 120. However, in following description, the operations will be described as being performed by the first electronic device 110 for convenience of explanation.

Referring to FIG. 2A, in operation 201, the first electronic device 110 may obtain a first image corresponding to a first display image having a pattern that is uniformly repeated. For example, the first electronic device 110 may photograph the first image output through the display 121 through the camera of the first electronic device 110.

In operation 203, the first electronic device 110 may obtain the second image corresponding to the second display image having the same gradation. For example, the first electronic device 110 may photograph the second image output through the display 121 through the camera of the first electronic device 110.

In operation 205, the first electronic device 110 may identify at least some deteriorated pixels of the display 121 by using the second image. For example, because the entire second image has the same gradation, the difference between the brightness of light output from deteriorated pixels and the brightness of light output from non-deteriorated pixels may be easily distinguished. That is, the pixel area where deterioration has occurred may be darker than the pixel area where deterioration has not occurred. Thus, the first electronic device 110 may use the second image to determine whether deterioration has occurred in the display 121.

In operation 207, the first electronic device 110 may use the first image to determine the location information of the deteriorated pixels. For example, the first image may be of a specified color (e.g., black) and may include an indicator line that divides the image into a plurality of blocks. In operation 207, the first electronic device 110 may combine the first and second images, and the first electronic device 110 may detect the location of the deteriorated pixel area (i.e. the darker pixel area) in the second image by using the first image, specifically by using the indicator line in the first image.

In operation 209, the first electronic device 110 may generate compensation information to compensate for the deteriorated pixels. The compensation information may include data (e.g. control information) for increasing the brightness of the deteriorated or degraded pixels and/or decreasing the brightness of the pixels where deterioration has not occurred. The first electronic device 110 may transmit the generated compensation information to the second electronic device 120.

FIG. 2B is a flowchart illustrating the operations of a first electronic device and/or a second electronic device according to another embodiment. All or some of the operations illustrated in FIG. 2B may be performed by the first electronic device 110 and/or the second electronic device 120. In the following description, for convenience of explanation, the operations will be described as being operated by the first electronic device 110.

Referring to FIG. 2B, in operation 211, the first electronic device 110 may obtain a first image and at least one second image. For example, the first electronic device 110 may photograph the first image and the at least one second image through the camera of the first electronic device 110.

In operation 213, the first electronic device 110 may display a second lattice pattern on the first image. In the present disclosure, the second lattice pattern may be a pattern obtained by dividing the first image into equal portions. The size of the divided portion may substantially correspond to the size of a pixel. According to an embodiment, operation 213 may correspond to a preprocessing operation of the present disclosure. In another embodiment, operation 213 may be omitted.

In operation 215, the first electronic device 110 may correct the first image such that the first lattice pattern corresponds to the second lattice pattern. For example, the first lattice pattern may be a pattern formed by controlling the pixels of the display of the second electronic device 120 to alternately output light of different colors. However, the size and location of the first lattice pattern may not be constant because the display panel on which the actual pixels are arranged is curved. Meanwhile, because the second lattice pattern is a pattern obtained by dividing the first image into specified portions, the size and location of the second lattice pattern may be constant. Accordingly, when the first image is corrected such that the first lattice pattern corresponds to the second lattice pattern, the first electronic device 110 may accurately determine the locations of each pixel.

In operation 217, the electronic device may detect deteriorated pixels based on the corrected first image and the at least one second image. For example, because the second image is generated by pixels outputting a single series of light, the difference between the brightness of light output from deteriorated pixels and the brightness of light output from non-deteriorated pixels may be easily distinguished. That is, the pixel area where deterioration has occurred may be darker than the pixel area where deterioration has not occurred. Because the first electronic device 110 accurately determines the locations of the pixels based on the first image and determines whether the deterioration has occurred based on the second image, the first electronic device 110 may accurately detect the locations of the deteriorated pixels.

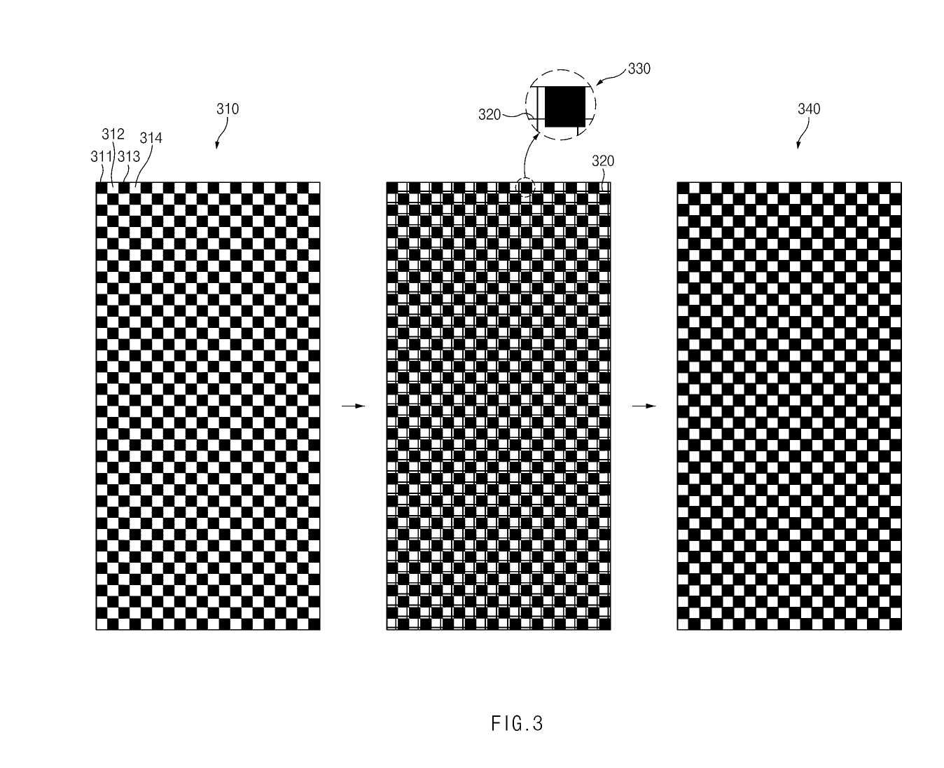

FIG. 3 are views illustrating a process in which an electronic device according to an embodiment corrects a first image. In other words, FIG. 3 further illustrates operations 211 to 215 shown in FIG. 2B in detail.

Referring to FIG. 3, the first electronic device 110 may obtain a first image 310. The first image 310 may include a first lattice pattern formed as the pixels included in the second electronic device 120 alternately emit light of different colors. For example, a first pattern 311 may be red, a second pattern 312 may be black, a third pattern 313 may be red, and a fourth pattern 314 may be black. The patterns may be repeated to form the first lattice pattern. When the first image 310 is output through the second electronic device 120, the first electronic device 110 may photograph the output first image 310. According to one or more other embodiment, the first image 310 may include other various patterns. For example, the first image 310 may include various patterns that are uniformly repeated over the entire display, and the patterns may have various shapes such as lines, points, etc.

The first electronic device 110 may display (i.e. superimpose) a second lattice pattern 320 on the first image 310. Because the second lattice pattern 320 is a pattern obtained by uniformly dividing the first image 310, and because the first image 310 may be output from a curved display, the second lattice pattern 320 may be different in size and position from the first lattice pattern. For example, as shown in an enlarged view 330, a minute gap may exist between the first lattice pattern and the second lattice pattern 320.

The first electronic device 110 may correct the first image 310 such that the first lattice pattern corresponds to the second lattice pattern 320. For example, at least some portions of the first lattice pattern may be moved, reduced, and/or enlarged such that there is no minute gap between the first lattice pattern and the second lattice pattern 320. When the first lattice pattern and the second lattice pattern 320 match each other, the first electronic device 110 may detect deteriorated pixels using the corrected first image 340.

In a conventional electronic device, the locations of the pixels in the first image may be calculated without matching the first lattice pattern and the second lattice pattern. But without this step, it is difficult to determine the actual locations of the deteriorated pixels when the display is curved. However, according to an embodiment of the disclosure, the first electronic device 110 and/or the second electronic device 120 may exactly determine the actual locations of the deteriorated pixels after matching the first lattice pattern and second lattice pattern 320.

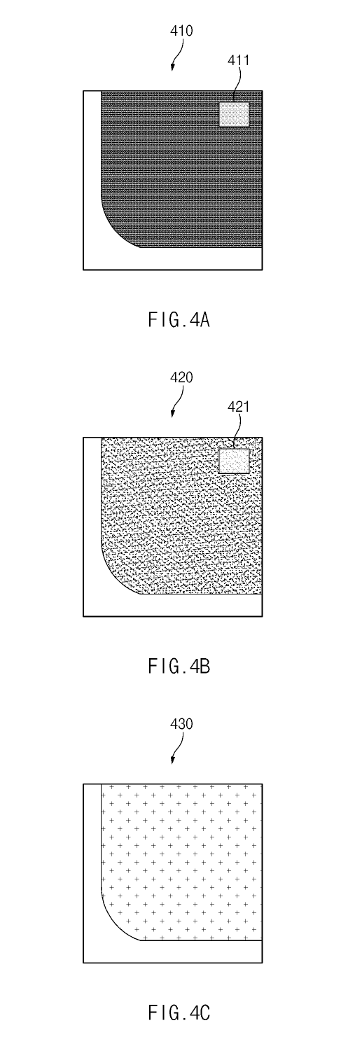

FIGS. 4A to 4C illustrate second images according to certain embodiments. FIG. 4A illustrates a second red image 410, FIG. 4B illustrates a second green image 420, and FIG. 4C illustrates a second blue image 430. In the present disclosure, the second red image 410 may be generated when the entire screen displayed on the display 121 of the second electronic device 120 is substantially uniform red. That is, the pixels included in the display 121 uniformly emit red light, meaning that only red sub-pixels among RGB sub-pixels emit light or red sub-pixels emit more light than green and blue sub-pixels and the remaining green and blue sub-pixels do not emit light or emit less light than the red pixels. The second green image 420 may be generated when the entire screen displayed on the display 121 of the second electronic device 120 is substantially uniform green. That is, the pixels included in the display 121 uniformly emit green light, meaning that only green sub-pixels among RGB sub-pixels emit light or green sub-pixels emit more light than red and blue sub-pixels and the remaining red and blue sub-pixels do not emit light or emit less light than the green pixels. The second blue image 430 may be generated when the entire screen displayed on the display 121 of the second electronic device 120 is substantially uniform blue. That is, the pixels included in the display 121 uniformly emit blue light, meaning that only blue sub-pixels among RGB sub-pixels emit light or blue sub-pixels emit more light than red and green sub-pixels and the remaining red and green sub-pixels do not emit light or emit less light less than the blue pixels. Hereinafter, the description of the second red image 410 may be applied to the second green image 420 and the second blue image 430 as well.

Referring to FIG. 4A, the second electronic device 120 may output at least one second red image 410 through the display 121. In this case, the first electronic device 110 may photograph the second red image 410 output through the second electronic device 120. Because the second red image 410 is an image formed when the entire screen displayed on the second electronic device 120 is substantially uniform red, it may be easy to distinguish the difference between the brightness of the light emitted from a deteriorated pixel and the brightness of the light emitted from a normal pixel. That is, the area where the deterioration has occurred may be darker than the area where the deterioration has not occurred. Thus, the first electronic device 110 may easily detect the deteriorated pixel based on the second red image 410. For example, when a first area 411 of the second red image 410 is darker than the remaining area, the first electronic device 110 may detect deteriorated pixels corresponding to the first area 411. According to one or more embodiments, the first electronic device 110 may photograph the second red image 410 of various gradations output through the second electronic device 120. In this case, the first electronic device 110 may detect the deteriorated pixel based on the second red images 410 of various gradations which are photographed a plurality of times.

According to an embodiment, the first electronic device 110 may compare the first image 310 with the second red image 410 to determine the location of the deteriorated pixel. For example, the first electronic device 110 may combine the first image 310 with the second red image 410. The first electronic device 110 may determine the location of the deteriorated area 411 from the first image 310. In this case, the first image 310 may be an image of alternatingly red and black patterns.

According to an embodiment, the first electronic device 110 may match the color of the first image 310 with the color of the second image when comparing the first image 310 with the second image. For example, when comparing the second green image 420 with the first image 310, the first image 310 may include a lattice pattern in which green and black are alternately output. Referring to FIG. 4B, the first electronic device 110 may detect whether a deteriorated area (e.g., a second area 421) exists in the second green image 420, and obtain the location of the deteriorated area 421 from the first image 310 (including a lattice pattern in which green and black are alternately output).

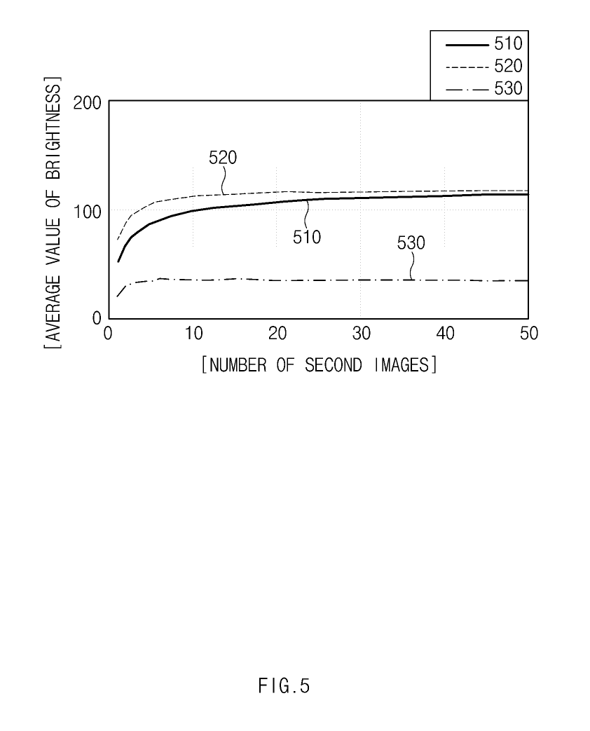

FIG. 5 is a graph illustrating average brightness values of second images according to an embodiment.

Referring to FIG. 5, the second electronic device 120 may output multiple second images through the display 121. For example, the second electronic device 120 may output at least 30 second red images 410, at least 30 second green images 420, and at least 30 second blue images 430 through the display 121. Each time a second image is output, the first electronic device 110 may photograph the second image. For example, when the second electronic device 120 outputs 30 second red images 410 or more, the first electronic device 110 may photograph all of the 30 or more second red images 410. In addition, the first electronic device 110 may photograph all the 30 second green images 420 or more and the 30 second blue images 430 or more.

When the multiple second images are photographed, the first electronic device 110 may calculate average values of brightness for each color. For example, when the first electronic device 110 photographs 30 second red images 410 or more, the first electronic device 110 may calculate the average value of the brightness of the second red image 410. The first electronic device 110 may compare the average value of the red color brightness with the first image 310 that includes a red and black lattice pattern, and may detect deteriorated pixels based on the comparison result.

A graph 510 represents the average value of the brightness of the second red image, and a graph 520 represents the average value of the brightness of the second green image. A graph 530 represents the average value of the brightness of the third blue image. Referring to the graphs 510, 520 and 530, it may be understood that the average value of the brightness gradually approaches a constant value as the number of the photographed second images increases. Therefore, by increasing the number of the photographed second images, error in detecting pixel deterioration by comparing the average value of brightness and the first image 310 may be reduced.

In a conventional electronic device, only one second image may be photographed. Thus, error in detecting deterioration may occur due to the deviation in brightness in the photographed second image. However, according to an embodiment of the disclosure, because multiple second images are photographed and the average of the second images is calculated to compare with the first image 310, the deviation in brightness in the photographed second images may be reduced. Accordingly, the first electronic device 110 and/or the second electronic device 120 according to an embodiment of the disclosure may detect deterioration with minimal error.

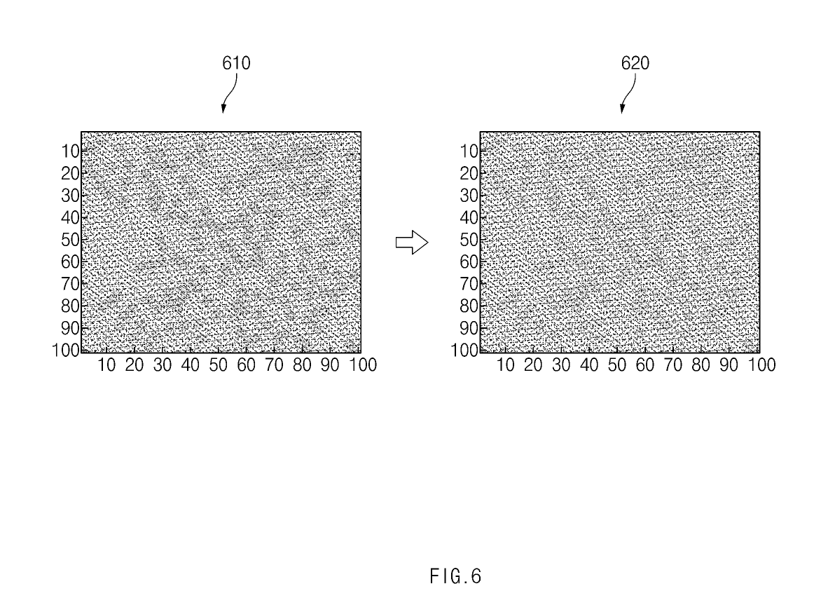

FIG. 6 is a view illustrating moires according to an embodiment.

In the present disclosure, the moire may refer to an interference pattern, a wave pattern, a lattice pattern, or the like output through the display 121, and may be interpreted as a type of noise.

Referring to FIG. 6, a first moire 610 represents noise output through a conventional electronic device. A second moire 620 represents noise output through the first electronic device 110 and/or the second electronic device 120 according to one or more embodiments of the disclosure.

Comparing the first moire 610 with the second moire 620, the conventional electronic device displays a relatively large amount of noise cause by pixel deterioration. However, the electronic device according to an embodiment of the disclosure may reduce noise by detecting pixel deterioration and compensating for the deterioration. Accordingly, the moire may be reduced in the output screen of the display 121 of the second electronic device 120.

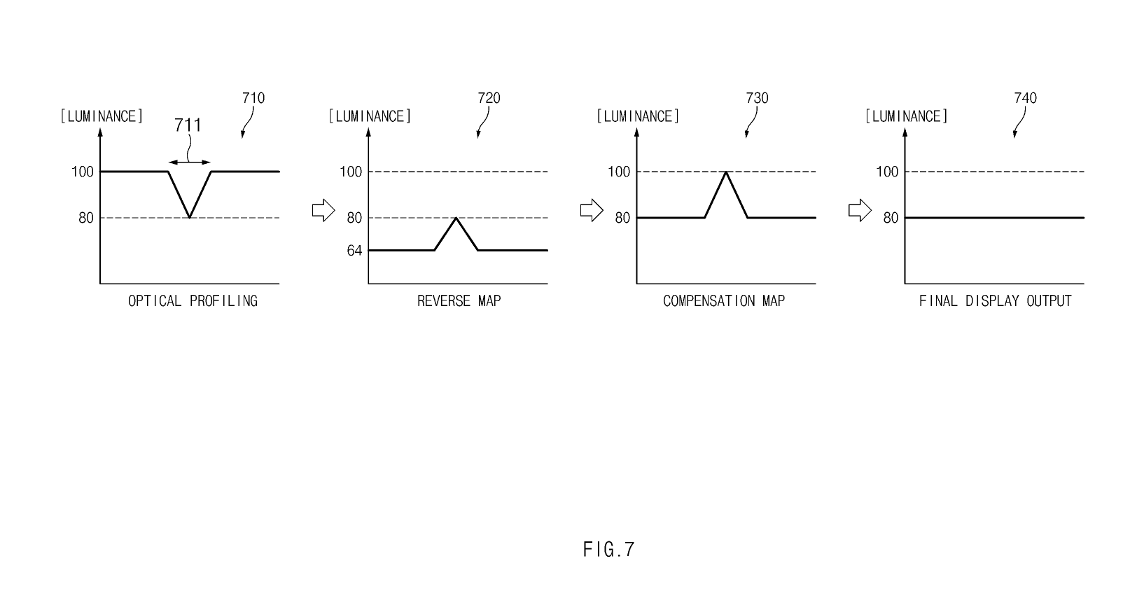

FIG. 7 are graphs illustrating compensation for pixel deterioration according to an embodiment. FIG. 7 may illustrate the compensation that may be performed after operation 209 shown in FIG. 2A.

A first graph 710 represents a deterioration detection result, and a second graph 720 represents a graph obtained by inverting the first graph 710. A third graph 730 represents a compensation map to be applied to the second electronic device 120, and a fourth graph 740 represents the luminance output from the display 121 of the second electronic device 120.

Referring to the first graph 710, because deterioration occurs in the second electronic device 120, a specific area on the display 121 may be darker than other areas. For example, the first electronic device 110 may determine that deterioration occurs in a first area 711 of the first graph 710.

Referring to the second graph 720, the first electronic device 110 may determine the degree of compensation by interpreting the first graph 710 in terms of a particular line to compensate for the deterioration. For example, the first electronic device 110 may determine the degree of compensation by inverting the first graph 710 with reference to the line of luminance 80.

Referring to the third graph 730, the first electronic device 110 may alter the second graph 720 to generate a compensation map. For example, the second graph 720 may be moved so that its base line 64 is moved to 80. Thus, in a section of the third graph 730 corresponding to the first area 711, the first electronic device 110 may generate a compensation map that can increase the brightness of the pixels. In the present disclosure, the compensation map may be data for controlling the brightness of the pixels included in the display 121. The compensation map may be generated by the first electronic device 110 and transmitted to the second electronic device 120, or may be generated by the second electronic device 120.

Referring to the fourth graph 740, the brightness of light output from the display 121 may be uniform. That is, even though the area where deterioration occurs exists, the second electronic device 120 increases the brightness of the area where the deterioration occurs, such that the brightness of the finally output light may be uniform.

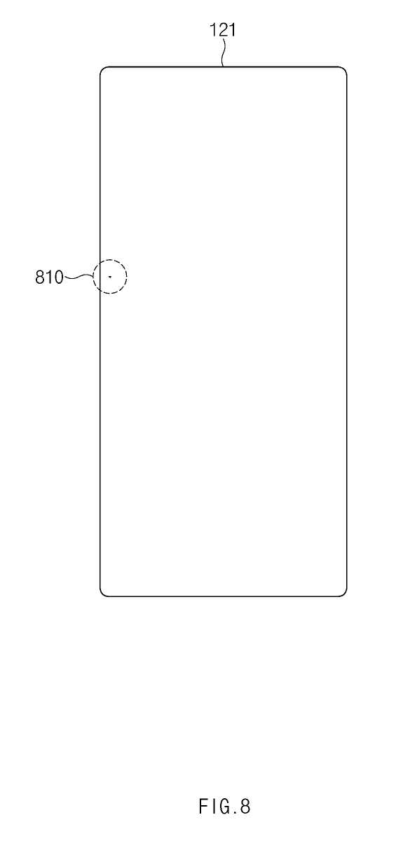

FIG. 8 shows a scratch on a display or a foreign substance adhering to the display according to an embodiment. FIG. 8 is a view illustrating a process of detecting deterioration when a scratch 810 is caused on the display 121 included in the second electronic device 120 or when foreign substances adhere thereto.

Referring to FIG. 8, when the display 121 is photographed by the first electronic device 110 in when the scratch 810 is formed on the display 121 or foreign substances adhere to the display 121, due to the scratch 810 or foreign substances, an error may occur in the deterioration detection result. However, according to an embodiment of the disclosure, the first electronic device 110 may operate a camera flash in the darkroom of the case device 130 to prevent the error. As the camera flash is activated, the degree of error caused by the scratch 810 or foreign substances on the first image 310 and/or the second image may be reduced.

According to another embodiment, noise generated by the scratch 810 or the foreign substances may be removed when analyzing in the first image 310 and/or the second image (e.g., reference numeral 410). Thus, the first electronic device 110 and/or the second electronic device 120 may reduce the possibility of error occurring in the process of detecting deterioration.

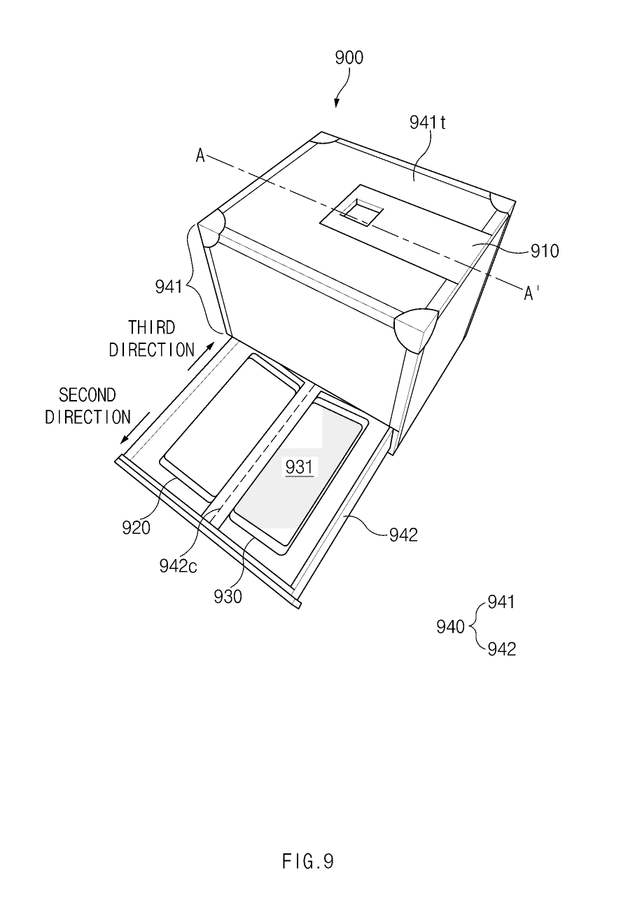

FIG. 9 illustrates an operating environment of an electronic device capable of measuring state data of a display according to another embodiment.

Referring to FIG. 9, in an operating environment 900 of an electronic device capable of measuring state data of a display, electronic device ‘a’ 910, and electronic device ‘b’ 920, and electronic device ‘c’ 930 may be mounted on a case device 940. In the disclosure, the electronic device ‘a’ 910 may be an electronic device capable of measuring state data of a display 931 included in the electronic device ‘c’ 930. The electronic device ‘b’ 920, which is to be compared with the electronic device ‘c’ 930, may be referred to as a reference electronic device. The electronic device ‘c’ 930 may be referred to as a measured electronic device. In the disclosure, the state data of the display may mean luminance, white balance, uniformity, and the like of the display 931.

The case device 940 may include a main body 941 and a containing part 942 inserted into the main body 941. The electronic device ‘a’ 910 may be arranged on an upper surface 941t of the main body 941. In this case, a camera of the electronic device ‘a’ 910 may be directed to the inside of the main body 941. According to an embodiment, because the main body 941 is sealed, the main body 941 may be a darkroom.

The containing part 942 may be slidably inserted into the main body 941. According to an embodiment, the containing part 942 may mount the electronic device ‘b’ 920 and the electronic device ‘c’ 930 thereon. The electronic device ‘b’ 920 and the electronic device ‘c’ 930 may be arranged to be symmetrical to each other about a central line 942c in the containing part 942. When the electronic device ‘b’ 920 and the electronic device ‘c’ 930 are mounted in the containing part 942, the containing part 942 may be inserted into the main body 941.

According to an embodiment, the electronic device ‘a’ 910 may photograph the electronic device ‘b’ 920 and the electronic device ‘c’ 930 through the camera in the state that the containing part 942 is inserted into the main body 941. The electronic device ‘a’ 910 may compare the image of the electronic device ‘b’ 920 with the image of the electronic device ‘c’ 930 and measure the white balance, uniformity and the like of display 931 included in the electronic device ‘c’ 930 based on the comparison result.

In the disclosure, the description of FIG. 9 may be equally applied to the configurations having the same reference numerals as those in the operating environment of the electronic device capable of measuring the state data of the display 931.

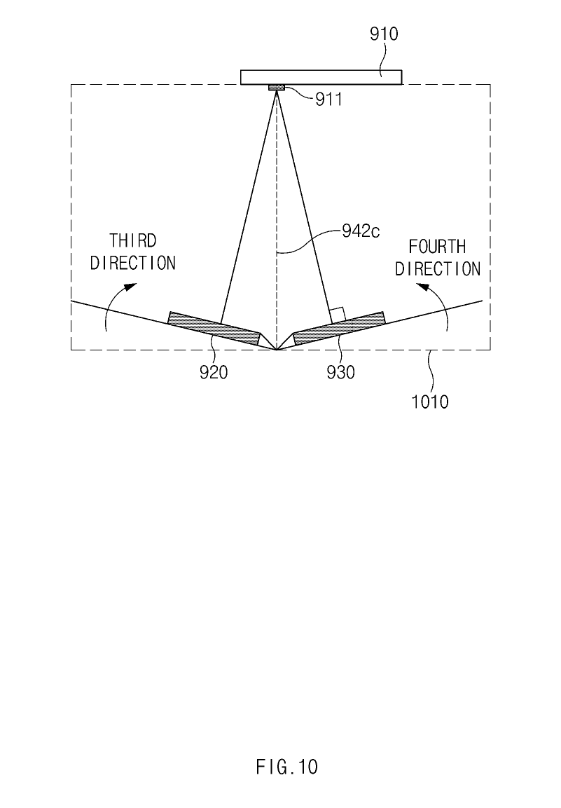

FIG. 10 is a cross-sectional view of a case device according to the other embodiment. FIG. 10 is a cross-sectional view taken along line A-A of the case device 940 shown in FIG. 9.

Referring to FIG. 10, the electronic device ‘b’ 920 and the electronic device ‘c’ 930 may be arranged to be symmetrical to each other with respect to the central line 942c in the case device 940. In this case, the electronic device ‘b’ 920 and the electronic device ‘c’ 930 may not be aligned on the same plane, but may be tilted to allow a camera 911 of the electronic device ‘a’ 910 to easily photograph an image output from the electronic device ‘b’ 920 and an image output from the electronic device ‘c’ 930. For example, the electronic device ‘b’ 920 may be tilted about 20 degrees in a third direction with respect to a plane 1010, and the electronic device ‘c’ 930 may be tilted about 20 degrees in a fourth direction with respect to a plane 1010.

The electronic device ‘a’ 910 may photograph images output from the tilted electronic device ‘b’ 920 and the tilted electronic device ‘c’ 930. Because the electronic device ‘b’ 920 and the electronic device ‘c’ 930 are tilted, the camera 911 may photograph front views of the electronic device ‘b’ 920 and the electronic device ‘c’ 930, so that the electronic device ‘a’ 910 may obtain clear images. When the images of the electronic device ‘b’ 920 and the electronic device ‘c’ 930 are obtained, the electronic device ‘a’ 910 may compare the image of the electronic device ‘b’ 920 with the image of the electronic device ‘c’ 930. The electronic device ‘a’ 910 may measure the white balance, uniformity, and the like of the display 931 included in the electronic device ‘c’ 930 based on the comparison result.

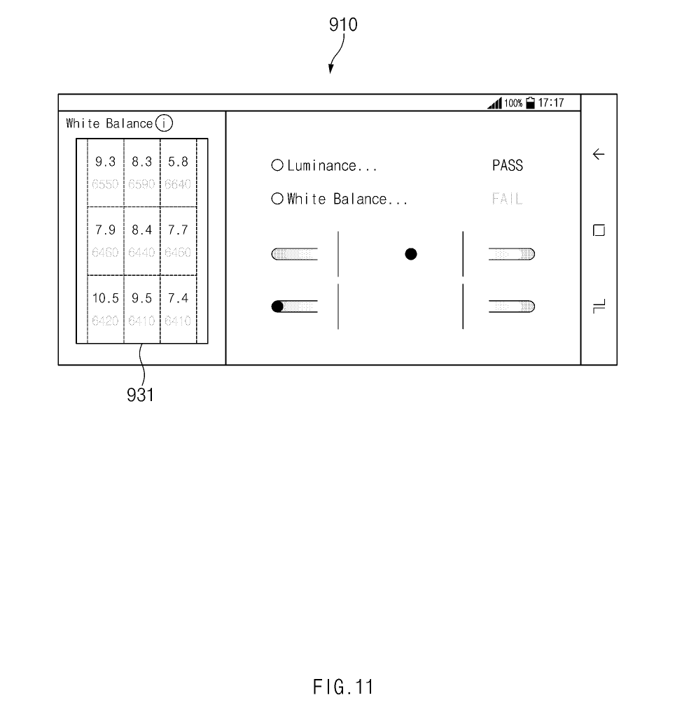

FIG. 11 shows an output screen of the electronic device ‘a’ 910 according to the other embodiment.

Referring to FIG. 11, the electronic device ‘a’ 910 may output the state data of the display 931 included in the electronic device ‘c’ 930 based on comparing the electronic device ‘b’ 920 and the electronic device ‘c’ 930. For example, the electronic device ‘a’ 910 may convert and output the brightness, white balance, and the like of the display 931 into numerical values, and may display whether the display 931 is abnormal based on the converted numerical values. When the converted values are outside specified ranges, the electronic device ‘a’ 910 may output “fail”. When the converted values are inside the specified ranges, the electronic device ‘a’ 910 may output “pass”.

According to an embodiment, the electronic device ‘a’ 910 may display whether the display 931 is abnormal by using a color. For example, when the converted values are outside specified ranges, the electronic device ‘a’ 910 may output the converted values and “fail” in red. To the contrary, when the converted values are in the specified ranges, the electronic device ‘a’ 910 may output the converted values and “pass” in green.

According to an embodiment, the electronic device ‘a’ 910 may divide the display 931 into various areas and output whether each divided area is abnormal. For example, as shown in FIG. 11, the electronic device ‘a’ 910 may divide the display 931 into nine areas and output whether each of the nine areas is abnormal. Meanwhile, the embodiment described in FIG. 11 is only an example, and the embodiments of the disclosure are not limited to those shown in FIG. 11. For example, the electronic device ‘a’ 910 may output brightness, white balance, uniformity, and the like of each pixel, and may output whether each pixel included in the display 931 is abnormal.

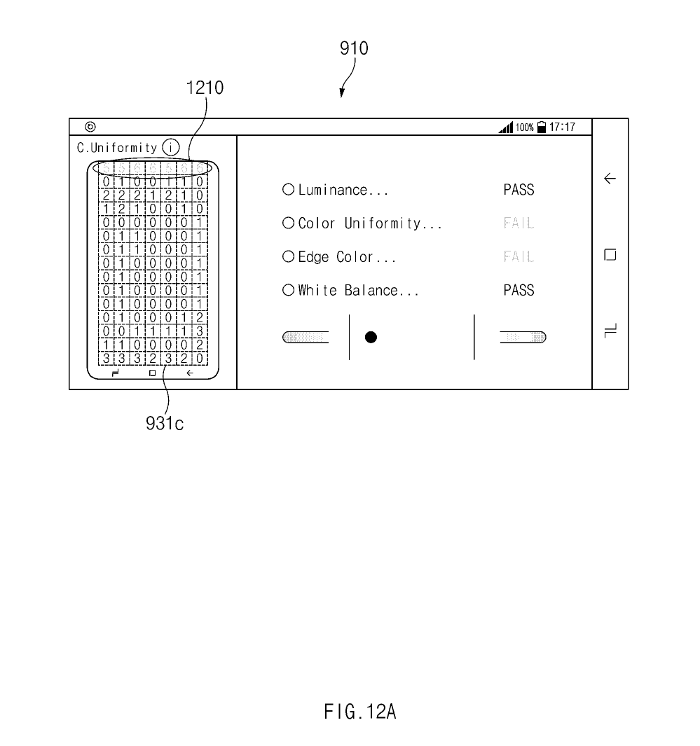

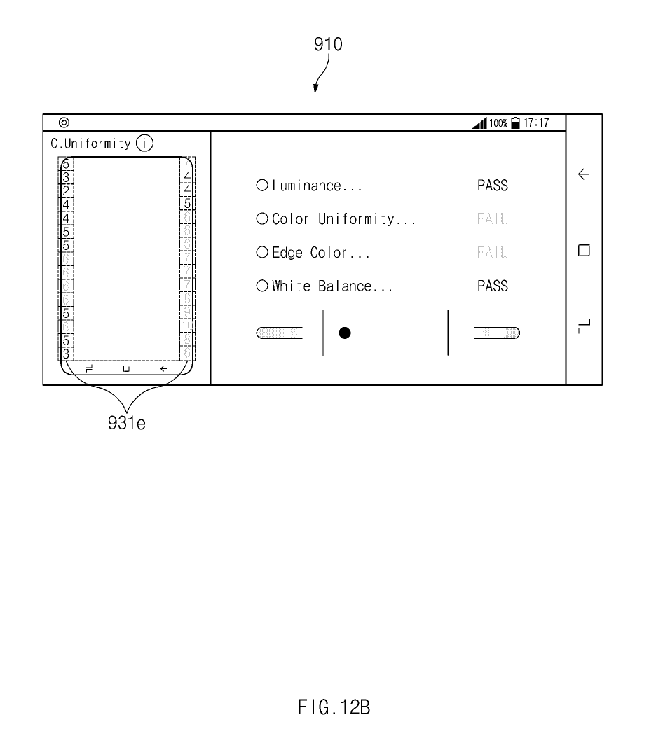

FIG. 12A is a view illustrating a screen obtained by the electronic device ‘a’ according to the other embodiment when measuring a middle area of electronic device ‘c’. FIG. 12B is a view illustrating a screen obtained by the electronic device ‘a’ according to the other embodiment when measuring an edge area of the electronic device ‘c.’

Referring to FIGS. 12A and 12B, the electronic device ‘a’ 910 may divide the display 931 into a middle area 931c and an edge area 931e and output whether each of the middle area 931c and the edge area 931e is abnormal. In addition, the electronic device ‘a’ 910 may output whether each pixel or each specified area in the middle area 931c and the edge area 931e is abnormal. For example, as shown in FIG. 12A, when the uniformity of pixels 1210 located on a first line in the middle area 931c is not constant, the electronic device ‘a’ 910 may output “fail”.

According to an embodiment, the middle area 931c may be somewhat flat, but the edge area 931e may be bent from the middle area 931c toward a rear cover. The middle area 931c and the edge area 931e may have different brightness, white balance, uniformity, and the like due to the above-described characteristics. For example, because the edge area 931e is bent, the uniformity may be lower than that of the middle area 931c. When the uniformity of the edge area 931e is below a specified range, the electronic device ‘a’ 910 may output the numerical value associated with the uniformity of the edge area 931e and “fail” in red.

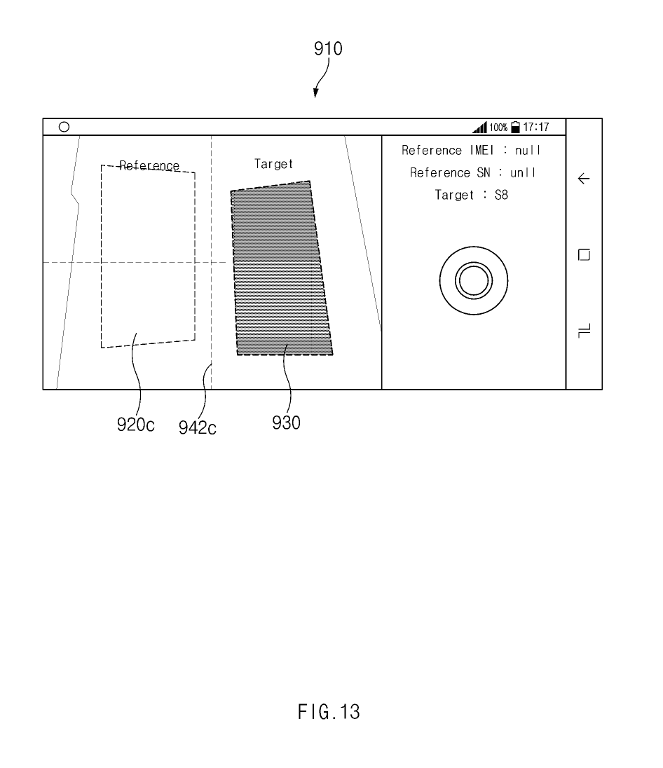

FIG. 13 is a view illustrating a layout of electronic device ‘b’ and electronic device ‘c’ according to yet another embodiment.

Referring to FIG. 13, even though the electronic device ‘c’ 930 is not symmetrically aligned with the electronic device ‘b’ 920 based on the central line 942c, the electronic device ‘a’ 910 may still output whether the display included in the electronic device ‘c’ 930 is abnormal. That is, even when a user inserts the containing part 942 into the main body 941 when the electronic device ‘c’ 930 is not straightly aligned, the electronic device ‘a’ 910 may output whether the display 931 included in the electronic device ‘c’ 930 is abnormal.

To do so, the electronic device ‘a’ 910 may compare the image in a middle area 920c of the display included in the electronic device ‘b’ 920 with the image of the electronic device ‘c’ 930 and may output whether the display 931 included in the display 931 is abnormal. Accordingly, the image provided as a reference on the electronic device ‘b’ 920 may have constant color and/or brightness. Thus, as shown in FIG. 13, even if the electronic device ‘c’ 930 is arranged obliquely, the electronic device ‘a’ 910 may output whether the display 931 is abnormal.

According to an embodiment of the disclosure, an electronic device includes a display, a camera, a communication circuit, a memory, and a processor, wherein the processor may obtain by using the camera or receive from an external device by using the communication circuit, a first image corresponding to a first display image having a uniformly repeated pattern and output through the display or another display included in the external device, obtain by using the camera or receive from the external device by using the communication circuit, a second image corresponding to a second display image having a same gradation, output through the display or the other display, identify one or more deteriorated pixels among a plurality of pixels included in the display or the other display by using the second image, determine location information of the one or more deteriorated pixels by using the uniformly repeated pattern included in the first image, and generate compensation information for the one or more deteriorated pixels based on the location information. The processor may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Certain of the functions and steps provided in the Figures may be implemented in hardware, software or a combination of both and may be performed in whole or in part within the programmed instructions of a computer. No claim element herein is to be construed under the provisions of 35 U.S.C. 112(f), unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. § 101.

According to an embodiment of the disclosure, the second image may include a plurality of images, and the processor may identify the one or more deteriorated pixels based on an average value of brightness of the plurality of images.

According to an embodiment of the disclosure, the first display image and the second display image may have a specified color.

According to an embodiment of the disclosure, the first display image may have a specified color and an indicator line that divides the first display image into a plurality of blocks.

According to an embodiment of the disclosure, the second display image may include a plurality of images having different brightnesses.

According to an embodiment of the disclosure, the first display image may include an alternating pattern of red and black, and the second display image may be a uniform red image.

According to an embodiment of the disclosure, the first display image may include an alternating pattern of green and black; and the second display image may be a uniform green image.

According to an embodiment of the disclosure, the first display image may include an alternating pattern of blue and black, and the second display image may be a uniform blue image.

According to an embodiment of the disclosure, the processor may photograph, through the camera, at least one of the first image and the second image which is output through the display and reflected by an external mirror.

According to an embodiment of the disclosure, at least one of the first image and the second image may be photographed by a camera including in the external device.

According to an embodiment of the disclosure, the processor may receive at least one of the first image and the second image through the communication circuit.

According to an embodiment of the disclosure, the generation of the compensation information may be performed by the external device, and the processor may receive the compensation information through the communication circuit.

According to an embodiment of the disclosure, the processor may increase brightness of the one or more deteriorated pixels or decrease brightness of at least one pixel among the plurality of pixels that is not deteriorated, based on the compensation information.

According to an embodiment of the disclosure, the first display image and the second display image may be output through the other display, and the processor may photograph at least one of the first image and the second image using the camera.

According to an embodiment of the disclosure, the communication circuit may further include a wireless communication circuit, and the processor may transmit the compensation information to the external device through the wireless communication circuit.

According to another embodiment of the disclosure, a method of detecting and compensating for deterioration of pixels included in a display or another display of an external device may include obtaining by using a camera or receiving from the external device by using a communication circuit, a first image corresponding to a first display image having a uniformly repeated pattern and output through the display or the other display included in the external device, obtaining by using the camera or receiving from the external device by using the communication circuit, a second image corresponding to a second display image having a same gradation and output through the display or the other display, identifying one or more deteriorated pixels among a plurality of pixels included in the display or the other display by using the second image, determining location information of the one or more deteriorated pixels by using the uniformly repeated pattern included in the first image, and generating compensation information for the one or more deteriorated pixels based on the location information.

According to an embodiment of the disclosure, the second image may include a plurality of images, and the method may further include identifying the one or more deteriorated pixels based on an average value of brightness of the plurality of images.

According to an embodiment of the disclosure, the first display image and the second display image may have a specified color.

According to an embodiment of the disclosure, the first display image may have a specified color and an indicator line that divides the first display image into a plurality of blocks s.

According to still another aspect of the disclosure, a server may include a communication circuit, and a processor electrically connected to the communication circuit, wherein the processor may receive, from a first external device by using the communication circuit, a first image corresponding to a first display image output through a display included in a second external device and having a uniformly repeated pattern, receive, from the first external device by using the communication circuit, a second image corresponding to a second display image having a same gradation and output through the display, identify one or more deteriorated pixels among a plurality of pixels included in the display by using the second image, determine location information of the one or more deteriorated pixels by using the uniformly repeated pattern included in the first image, generate compensation information for the one or more deteriorated pixels based on the location information, and transmit the generated compensation information to the second external device through the communication circuit.

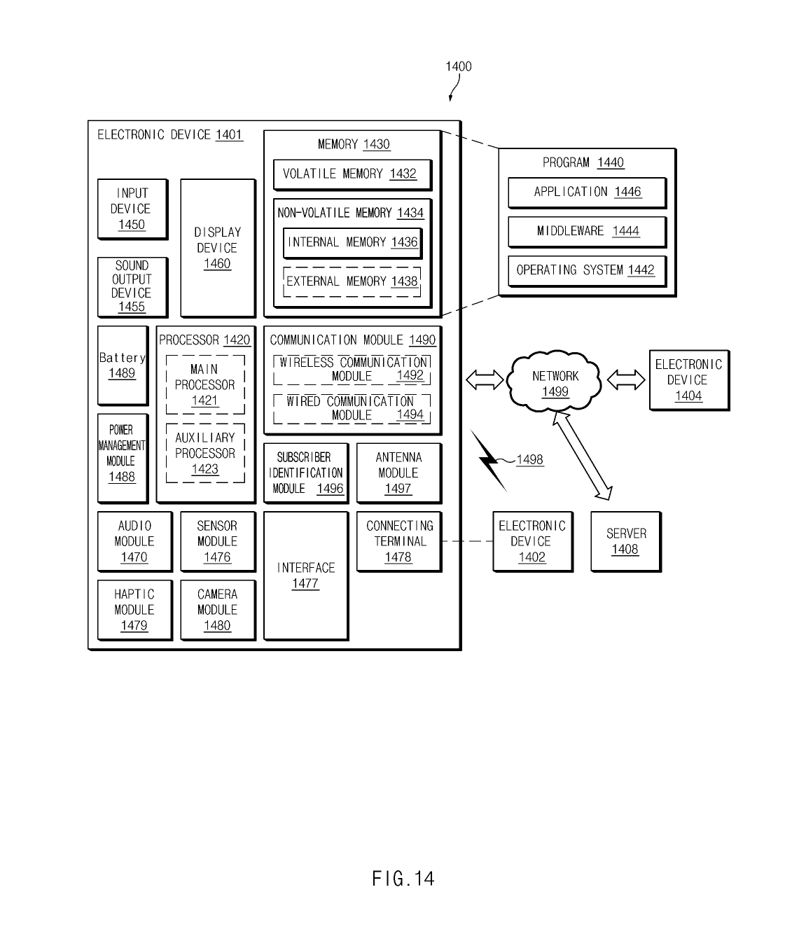

FIG. 14 is a block diagram of an electronic device in a network environment according to certain embodiments.

Referring to FIG. 14, an electronic device 1401 may communicate with an electronic device 1402 through a first network 1498 (e.g., a short-range wireless communication) or may communicate with an electronic device 1404 or a server 1408 through a second network 1499 (e.g., a long-distance wireless communication) in a network environment 1400. According to an embodiment, the electronic device 1401 may communicate with the electronic device 1404 through the server 1408. According to an embodiment, the electronic device 1401 may include a processor 1420, a memory 1430, an input device 1450, a sound output device 1455, a display device 1460, an audio module 1470, a sensor module 1476, an interface 1477, a haptic module 1479, a camera module 1480, a power management module 1488, a battery 1489, a communication module 1490, a subscriber identification module 1496, and an antenna module 1497. According to some embodiments, at least one (e.g., the display device 1460 or the camera module 1480) among components of the electronic device 1401 may be omitted or other components may be added to the electronic device 1401. According to some embodiments, some components may be integrated and implemented as in the case of the sensor module 1476 (e.g., a fingerprint sensor, an iris sensor, or an illuminance sensor) embedded in the display device 1460 (e.g., a display).

The processor 1420 may operate, for example, software (e.g., a program 1440) to control at least one of other components (e.g., a hardware or software component) of the electronic device 1401 connected to the processor 1420 and may process and compute a variety of data. The processor 1420 may load a command set or data, which is received from other components (e.g., the sensor module 1476 or the communication module 1490), into a volatile memory 1432, may process the loaded command or data, and may store result data into a nonvolatile memory 1434. According to an embodiment, the processor 1420 may include a main processor 1421 (e.g., a central processing unit or an application processor) and an auxiliary processor 1423 (e.g., a graphic processing device, an image signal processor, a sensor hub processor, or a communication processor), which operates independently from the main processor 1421, additionally or alternatively uses less power than the main processor 1421, or is specified to a designated function. In this case, the auxiliary processor 1423 may operate separately from the main processor 1421 or embedded.

In this case, the auxiliary processor 1423 may control, for example, at least some of functions or states associated with at least one component (e.g., the display device 1460, the sensor module 1476, or the communication module 1490) among the components of the electronic device 1401 instead of the main processor 1421 while the main processor 1421 is in an inactive (e.g., sleep) state or together with the main processor 1421 while the main processor 1421 is in an active (e.g., an application execution) state. According to an embodiment, the auxiliary processor 1423 (e.g., the image signal processor or the communication processor) may be implemented as a part of another component (e.g., the camera module 1480 or the communication module 1490) that is functionally related to the auxiliary processor 1423. The memory 1430 may store a variety of data used by at least one component (e.g., the processor 1420 or the sensor module 1476) of the electronic device 1401, for example, software (e.g., the program 1440) and input data or output data with respect to commands associated with the software. The memory 1430 may include the volatile memory 1432 or the nonvolatile memory 1434.

The program 1440 may be stored in the memory 1430 as software and may include, for example, an operating system 1442, a middleware 1444, or an application 1446.

The input device 1450 may be a device for receiving a command or data, which is used for a component (e.g., the processor 1420) of the electronic device 1401, from an outside (e.g., a user) of the electronic device 1401 and may include, for example, a microphone, a mouse, or a keyboard.

The sound output device 1455 may be a device for outputting a sound signal to the outside of the electronic device 1401 and may include, for example, a speaker used for general purposes, such as multimedia play or recordings play, and a receiver used only for receiving calls. According to an embodiment, the receiver and the speaker may be either integrally or separately implemented.

The display device 1460 may be a device for visually presenting information to the user of the electronic device 1401 and may include, for example, a display, a hologram device, or a projector and a control circuit for controlling a corresponding device. According to an embodiment, the display device 1460 may include a touch circuitry or a pressure sensor for measuring an intensity of pressure on the touch.

The audio module 1470 may convert a sound and an electrical signal in dual directions. According to an embodiment, the audio module 1470 may obtain the sound through the input device 1450 or may output the sound through an external electronic device (e.g., the electronic device 1402 (e.g., a speaker or a headphone)) wired or wirelessly connected to the sound output device 1455 or the electronic device 1401.

The sensor module 1476 may generate an electrical signal or a data value corresponding to an operating state (e.g., power or temperature) inside or an environmental state outside the electronic device 1401. The sensor module 1476 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 1477 may support a designated protocol wired or wirelessly connected to the external electronic device (e.g., the electronic device 1402). According to an embodiment, the interface 1477 may include, for example, an HDMI (high-definition multimedia interface), a USB (universal serial bus) interface, an SD card interface, or an audio interface.

A connecting terminal 1478 may include a connector that physically connects the electronic device 1401 to the external electronic device (e.g., the electronic device 1402), for example, an HDMI connector, a USB connector, an SD card connector, or an audio connector (e.g., a headphone connector).

The haptic module 1479 may convert an electrical signal to a mechanical stimulation (e.g., vibration or movement) or an electrical stimulation perceived by the user through tactile or kinesthetic sensations. The haptic module 1479 may include, for example, a motor, a piezoelectric element, or an electric stimulator.

The camera module 1480 may shoot a still image or a video image. According to an embodiment, the camera module 1480 may include, for example, at least one lens, an image sensor, an image signal processor, or a flash.

The power management module 1488 may be a module for managing power supplied to the electronic device 1401 and may serve as at least a part of a power management integrated circuit (PMIC).

The battery 1489 may be a device for supplying power to at least one component of the electronic device 1401 and may include, for example, a non-rechargeable (primary) battery, a rechargeable (secondary) battery, or a fuel cell.

The communication module 1490 may establish a wired or wireless communication channel between the electronic device 1401 and the external electronic device (e.g., the electronic device 1402, the electronic device 1404, or the server 1408) and support communication execution through the established communication channel. The communication module 1490 may include at least one communication processor operating independently from the processor 1420 (e.g., the application processor) and supporting the wired communication or the wireless communication. According to an embodiment, the communication module 1490 may include a wireless communication module 1492 (e.g., a cellular communication module, a short-range wireless communication module, or a GNSS (global navigation satellite system) communication module) or a wired communication module 1494 (e.g., an LAN (local area network) communication module or a power line communication module) and may communicate with the external electronic device using a corresponding communication module among them through the first network 1498 (e.g., the short-range communication network such as a Bluetooth, a WiFi direct, or an IrDA (infrared data association)) or the second network 1499 (e.g., the long-distance wireless communication network such as a cellular network, an internet, or a computer network (e.g., LAN or WAN)). The above-mentioned various communication modules 1490 may be implemented into one chip or into separate chips, respectively.

According to an embodiment, the wireless communication module 1492 may identify and authenticate the electronic device 1401 using user information stored in the subscriber identification module 1496 in the communication network.

The antenna module 1497 may include one or more antennas to transmit or receive the signal or power to or from an external source. According to an embodiment, the communication module 1490 (e.g., the wireless communication module 1492) may transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 1401 and the external electronic device 1404 through the server 1408 connected to the second network 1499. Each of the electronic devices 1402 and 1404 may be the same or different types as or from the electronic device 1401. According to an embodiment, all or some of the operations performed by the electronic device 1401 may be performed by another electronic device or a plurality of external electronic devices. When the electronic device 1401 performs some functions or services automatically or by request, the electronic device 1401 may request the external electronic device to perform at least some of the functions related to the functions or services, in addition to or instead of performing the functions or services by itself. The external electronic device receiving the request may carry out the requested function or the additional function and transmit the result to the electronic device 1401. The electronic device 1401 may provide the requested functions or services based on the received result as is or after additionally processing the received result. To this end, for example, a cloud computing, distributed computing, or client-server computing technology may be used.

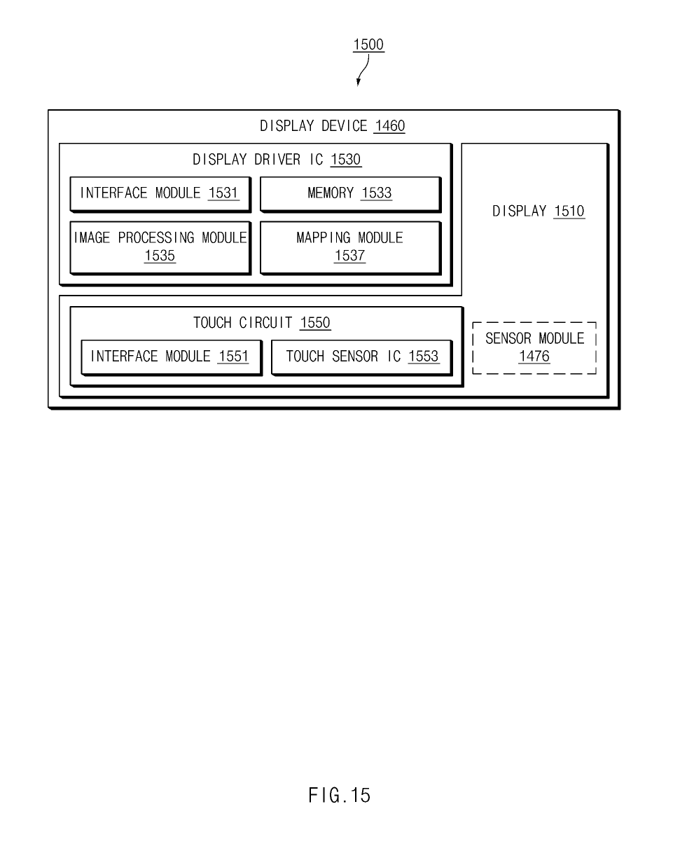

FIG. 15 is a block diagram of a display device according to certain embodiments.

Referring to FIG. 15, the display device 1460 may include a display 1510 and a display driver IC (DDI) 1530 for controlling the display 1510. The DDI 1530 may include an interface module 1531, a memory 1533 (e.g., a buffer memory), an image processing module 1535, or a mapping module 1537. For example, the DDI 1530 may receive image information including image data or an image control signal corresponding to a command for controlling the image data from a processor 1420 (e.g., a main processor 1421 or an application processor) or an auxiliary processor 1423, which is operated independently of the main processor 1421, through the interface module 1531. The DDI 1530 may communicate with a touch circuit 1550, the sensor module 1476, or the like through the interface module 1531. In addition, the DDI 1530 may store at least a part of the received image information in the memory 1533, for example, in units of frames. For example, the image processing module 1535 may perform preprocessing or post-processing (e.g., adjustment of resolution, brightness, or size) on at least a part of the image data based at least partially on characteristics of the image data or the display 1510. The mapping module 1537 may convert the image data preprocessed or post-processed through the image processing module 1535 into a voltage value or a current value capable of driving the pixels, based at least partially on attributes of the pixels of the display 1510 (e.g., an array of pixels (RGB stripe or pentile) or a size of each of subpixels). For example, at least some pixels of the display 1510 may be driven based on the voltage or current value, such that visual information (e.g., a text, an image, or an icon) corresponding to the image data is displayed on the display 1510.

According to an embodiment, the display device 1460 may further include the touch circuit 1550. The touch circuit 1550 may include a touch sensor 1551 and a touch sensor IC 1553 for controlling the touch sensor 1551. The touch sensor IC 1553 may controls the touch sensor 1551 to measure, for example, a change in a signal (e.g., a voltage, a light amount, a resistance, or a charge amount) at a specific position of the display 1510 to sense a touch input or a hovering input, and may provide information (e.g., a location, an area, a pressure or a time) about the sensed touch input or hovering input to the processor 1420. According to an embodiment, at least a part (e.g., the touch sensor IC 1553) of the touch circuit 1550 may be included as a part of the display driver IC 1530 or the display 1510, or as a part of another component (e.g., the auxiliary processor 1423) arranged outside the display device 1460.

According to an embodiment, the display device 1460 may further include at least one sensor (e.g., a fingerprint sensor, an iris sensor, a pressure sensor or an illuminance sensor) of the sensor module 1476, or a control circuitry thereof In this case, the at least one sensor or the control circuitry thereof may be embedded in a part (e.g., the display 1510 or the DDI 1530) of the display device 1460 or a part of the touch circuit 1550. For example, when the sensor module 1476 embedded in the display device 1460 includes a biometric sensor (e.g., a fingerprint sensor), the biometric sensor may obtain biometric information associated with a touch input through an area of the display 1510. As another example, when the sensor module 1476 embedded in the display device 1460 includes a pressure sensor, the pressure sensor may obtain information about a pressure corresponding to a touch input through an area or entire area of the display 1510. According to an embodiment, the touch sensor 1551 or the sensor module 1476 may be arranged between pixels of the pixel layer of the display 1510, or above or below the pixel layer.

The electronic device according to certain embodiments disclosed in the disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment of the disclosure should not be limited to the above-mentioned devices.

It should be understood that certain embodiments of the disclosure and terms used in the embodiments do not intend to limit technologies disclosed in the disclosure to the particular forms disclosed herein; rather, the disclosure should be construed to cover various modifications, equivalents, and/or alternatives of embodiments of the disclosure. With regard to description of drawings, similar components may be assigned with similar reference numerals. As used herein, singular forms may include plural forms as well unless the context clearly indicates otherwise. In the disclosure disclosed herein, the expressions “A or B”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to as being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the disclosure may be implemented by software (e.g., the program 1440) including an instruction stored in a machine-readable storage media (e.g., an internal memory 1436 or an external memory 1438) readable by a machine (e.g., a computer). The machine may be a device that calls the instruction from the machine-readable storage media and operates depending on the called instruction and may include the electronic device (e.g., the electronic device 1401). When the instruction is executed by the processor (e.g., the processor 1420), the processor may perform a function corresponding to the instruction directly or using other components under the control of the processor. The instruction may include a code made by a compiler or a code executable by an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to certain embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to certain embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to certain embodiments of the disclosure may be executed sequentially, in parallel, repeatedly, or in a heuristic method. Also, at least some operations may be executed in different sequences, omitted, or other operations may be added.

According to one or more embodiments of the disclosure, deterioration occurring in a display may be detected and compensated.

In addition, various effects that are directly or indirectly understood through the disclosure may be provided.

Certain of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

While the disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a camera;
a communication circuit;
a memory; and
a processor,
wherein the processor is configured to:
obtain by using the camera or receive from an external device by using the communication circuit, a first image corresponding to a first display image having a uniformly repeated pattern and output through the display or another display included in the external device;
obtain by using the camera or receive from the external device by using the communication circuit, a second image corresponding to a second display image having a same gradation and output through the display or the other display;
identify one or more deteriorated pixels among a plurality of pixels included in the display or the other display by using the second image;
determine location information of the one or more deteriorated pixels by using the uniformly repeated pattern included in the first image; and
generate compensation information for the one or more deteriorated pixels based on the location information.

2. The electronic device of claim 1, wherein the second image includes a plurality of images, and the processor is further configured to identify the one or more deteriorated pixels based on an average value of brightness of the plurality of images.

3. The electronic device of claim 1, wherein the first display image and the second display image have a specified color.

4. The electronic device of claim 3, wherein the second display image includes a plurality of images having different brightnesses.

5. The electronic device of claim 1, wherein the first display image has a specified color and an indicator line that divides the first display image into a plurality of blocks.

6. The electronic device of claim 1, wherein the first display image includes an alternating pattern of red and black; and
wherein the second display image is a uniform red image.

7. The electronic device of claim 1, wherein the first display image includes an alternating pattern of green and black; and
wherein the second display image is a uniform green image.

8. The electronic device of claim 1, wherein the first display image includes an alternating pattern of blue and black; and
wherein the second display image is a uniform blue image.

9. The electronic device of claim 1, wherein the processor is further configured to photograph, through the camera, at least one of the first image and the second image which is output through the display and reflected by an external mirror.

10. The electronic device of claim 1, wherein at least one of the first image and the second image are photographed by a camera including in the external device.

11. The electronic device of claim 10, wherein the processor is configured to receive at least one of the first image and the second image through the communication circuit.

12. The electronic device of claim 11, wherein the generation of the compensation information is performed by the external device, and the processor is further configured to receive the compensation information through the communication circuit.

13. The electronic device of claim 1, wherein the processor is further configured to increase brightness of the one or more deteriorated pixels or decrease brightness of at least one pixel among the plurality of pixels that is not deteriorated, based on the compensation information.

14. The electronic device of claim 1, wherein the first display image and the second display image are output through the other display, and
wherein the processor is configured to photograph at least one of the first image and the second image using the camera.

15. The electronic device of claim 14, wherein the communication circuit further includes a wireless communication circuit, and
wherein the processor is further configured to transmit the compensation information to the external device through the wireless communication circuit.

16. A method of detecting and compensating for deterioration of pixels included in a display or another display of an external device, the method comprising:
obtaining by using a camera or receiving from the external device by using a communication circuit, a first image corresponding to a first display image having a uniformly repeated pattern and output through the display or the other display included in the external device;
obtaining by using the camera or receiving from the external device by using the communication circuit, a second image corresponding to a second display image having a same gradation and output through the display or the other display;
identifying one or more deteriorated pixels among a plurality of pixels included in the display or the other display by using the second image;
determining location information of the one or more deteriorated pixels by using the uniformly repeated pattern included in the first image; and
generating compensation information for the one or more deteriorated pixels based on the location information.

17. The method of claim 16, wherein the second image includes a plurality of images, and the method further comprises:
identifying the one or more deteriorated pixels based on an average value of brightness of the plurality of images.

18. The method of claim 16, wherein the first display image and the second display image have a specified color.

19. The method of claim 16, wherein the first display image has a specified color and an indicator line that divides the first display image into a plurality of blocks.

20. A server comprising:
a communication circuit; and
a processor electrically connected to the communication circuit,
wherein the processor is configured to:
receive, from a first external device by using the communication circuit, a first image corresponding to a first display image output through a display included in a second external device and having a uniformly repeated pattern;
receive, from the first external device by using the communication circuit, a second image corresponding to a second display image having a same gradation and output through the display;
identify one or more deteriorated pixels among a plurality of pixels included in the display by using the second image;
determine location information of the one or more deteriorated pixels by using the uniformly repeated pattern included in the first image;
generate compensation information for the one or more deteriorated pixels based on the location information; and
transmit the generated compensation information to the second external device through the communication circuit.
